(19) United States
(12) Patent Application Publication
(10) Pub. No.: US 2011/0113854 A1
(43) Pub. Date: May 19, 2011

(54) DEVICE FOR OPERATING A PARTICLE SENSOR

(75) Inventors: Thomas Marc Kammerer, Homburg (DE); Anselm Gademann, Rottenburg (DE); Mathias Klenk, Tuebingen (DE); Thorsten Ochs, Schwieberdingen (DE); Bernhard Kamp, Ludwigsburg (DE)

(73) Assignee: Robert Bosch GMBH, Stuttgart (DE)

(21) Appl. No.: 12/948,306

(22) Filed: Nov. 17, 2010

(30) Foreign Application Priority Data
Nov. 17, 2009 (DE) 10 2009 046 749.1

(51) Int. Cl. G01N 7/00

(52) U.S. Cl. 73/23.31

(57) ABSTRACT

The invention relates to a device for operating a particle sensor in the exhaust gas duct of an internal combustion engine, the particle sensor comprising an interdigital electrode for determining the particles contained in the exhaust gas and a heater for regenerating said particle sensor and an engine management system being associated with the internal combustion engine. Provision is thereby made for a probe control unit to be connected to said particle sensor, for the probe control unit to be disposed in a separate assembly between said particle sensor and the engine management system and for said probe control unit to be connected to said engine management system via a digital bus or an analog interface. The invention relates further to a corresponding method. Device and method allow for the autonomous operation of a particle sensor without the engine management system having to be configured for the operation of said particle sensor.

This application is claims benefit of Serial No. 10 2009 046 749.1, filed 17 Nov. 2009 in Germany and which application is incorporated herein by reference. To the extent appropriate, a claim of priority is made to the above disclosed application.

### BACKGROUND

The invention relates to a device for operating a particle sensor in the exhaust gas duct of an internal combustion engine. The particle sensor comprises an interdigital electrode for determining the particles contained in the exhaust gas and a heater for regenerating said particle sensor, and an engine management system is associated with the internal combustion engine.

The invention relates further to a method for evaluating, activating and regenerating a particle sensor in the exhaust gas duct of an internal combustion engine having an engine management system.

Statutory regulations stipulate the monitoring of the composition of exhaust gas of internal combustion engines to ensure compliance with limit values. Furthermore, the functioning of emission control components is monitored with exhaust gas sensors within the scope of a self-diagnosis. By way of example, the filtering effect of a particle filter can be monitored with a particle sensor respectively upstream of and downstream of said particle filter. To meet this objective, the exhaust gas sensors are connected to an engine management module of the internal combustion engine, in which the signals of said sensors are evaluated. If a modified or additional exhaust gas sensor is used, changes and if need be hardware extensions must be undertaken at the engine management module. If in the case of a particle sensor, the operating strategy thereof, as by way of example regeneration cycles or trigger limit values, is changed, this likewise necessitates an intervention into the engine management module.

It is the aim of the invention to provide a device for operating a particle sensor, whereby provision is made for only slight changes in the engine management system of the internal combustion engine for the operation of the particle sensor.

It is furthermore the aim of the invention to provide a corresponding method.

### SUMMARY

The aim of the invention relating to the device is thereby met because of the fact that a probe control unit is associated with the particle sensor, the probe control unit is disposed in a separate assembly between said particle sensor and the engine management system and said probe control unit is connected to said engine management system via a digital bus or an analog interface. Said probe control unit allows the entire operating strategy of the particle sensor to be executed in this probe control unit. In so doing, said probe control unit can be fixedly connected to the particle sensor, for example by means of integration into the sensor cable harness. Through the use of said probe control unit, no significant changes in the hard- and software of the engine management module, which in prior art systems assumes the control and evaluation of the particle sensor, have to be provided for operating a particle sensor. Said probe control unit can be optimally adapted to the demands of the particle sensor, for example in the case of a further technical development to the particle sensor, without necessitating changes in the engine management module.

Corresponding to a particularly preferred modification to the embodiment of the invention, provision can be made for the probe control unit to contain at least an electrode voltage supply and a current measuring circuit for the interdigital electrode, a heater voltage supply for the heater, a control logic circuit and a digital bus interface for connecting to an engine management system. Hence the probe control unit contains all of the necessary components for determining the particle loading of the particle sensor via the interdigital electrode and the regeneration of said particle sensor by the heater. By integrating the control logic into said probe control unit, the particle sensor can be autonomously operated by means of said probe control unit. The connection to the engine management module allows among other things for said probe control unit to be able to react to the operating state of the internal combustion engine, which is detected by the engine management module or is predetermined.

A simple and flexible implementation of the control logic in the probe control unit can be achieved by said control logic being set up as a microcontroller with a program sequence.

Particularly if a temperature sensor is present on the particle sensor, provision can be made for the probe control unit to contain a temperature measuring circuit for evaluating a temperature signal of the temperature sensor disposed on the particle sensor and a temperature control for controlling the temperature of the particle sensor. This allows for the measurement of the temperature and the exact temperature regulation during the regeneration of the particle sensor.

The aim of the invention relating to the method is thereby met because of the fact that the measuring signals of the particle sensor are provided to a separately disposed probe control unit and because of the fact that said measuring signals are preprocessed in analog form, digitalized, further processed by the control logic and forwarded to the engine management system via an analog or digital interface.

Provision can thereby be made in the probe control unit for a comparison of the parameters of the particle sensor, a self-diagnosis of said probe control unit and the particle sensor, the triggering and control of a regeneration of said particle sensor and a comparison of operating parameters of said particle sensor to take place so as in each case to be considered separately or in combination of the steps of the present method.

The method allows for the autonomous operation of the particle sensor by means of the separate probe control unit without significant intervention of the engine management system. In so doing, the evaluation as well as the regeneration of said particle sensor takes place via said probe control unit. The operating strategy can, for example in the case of a model change of the particle sensor, be optimally adapted to the present particle sensor without an adaptation of the engine management system being necessary. Ageing effects of said particle sensor can, for example, be taken into account by the autonomous comparison of the operating parameters over the service life of said particle sensor.

### BRIEF DESCRIPTION OF THE DRAWING

The invention is explained below in detail using an exemplary embodiment depicted in the figure. The following is shown:

FIG. 1 is a particle sensor having a probe control unit

### DETAILED DESCRIPTION

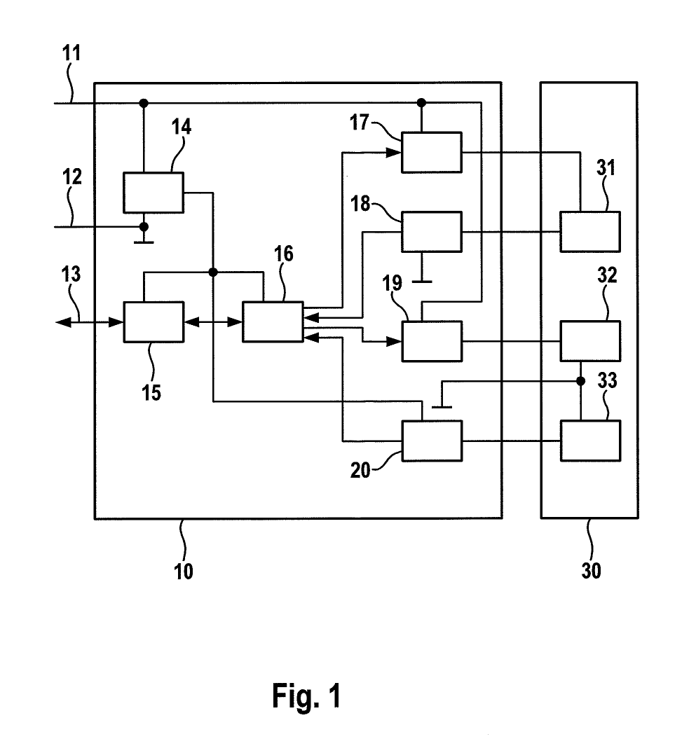

FIG. 1 shows a probe control unit 10 and a particle sensor 30 connected thereto via a sensor cable harness. The particle sensor 30 is disposed in the exhaust gas duct of an internal combustion engine. The probe control unit 10 is connected to an engine management system of the internal combustion engine. Said particle sensor 30 comprises an interdigital electrode 31, a heater 32 and a temperature sensor 33. Said probe control unit 10 comprises a 5V supply 14, which includes a supply voltage 11 and a ground connection 12 via a vehicle cable harness. Said probe control unit 10 further comprises a CAN bus controller 15, a microcontroller 16, an electrode voltage supply 17, a first measuring unit 18, a heater voltage supply 19 and a second measuring unit 20. Besides the 5V supply 14, the supply voltage 11 also provides the electrode voltage supply 17 and the heater voltage supply 19. The 5V supply 14 provides the CAN bus controller 15, the microcontroller 16, the first measuring unit 18 and the second measuring unit 20 with 5V operating voltage. The electrode voltage supply 17 provides the interdigital electrode 31 with operating voltage. The first measuring unit 18 contains a current measurement circuit, which determines the current flow through the interdigital electrode 31 as a function of the load of said interdigital electrode 31 and relays this information to the microcontroller 16. Said microcontroller 16 controls said electrode voltage supply 17.

The heater voltage supply 19 supplies the heater 32 with operating voltage, the heat output of the microcontroller 16 being thereby defined. The second measuring unit 20 acquires the data of the temperature sensor 33, converts said data and forwards them to said microcontroller 16, in which a program sequence for controlling the heat output on the basis of the data of said temperature sensor 33 is provided. Said microcontroller 16 exchanges data with the engine management system of the internal combustion engine via the CAN bus controller 15 and a data line 13. Especially information about the particle loading of the exhaust gas, which was derived from the signals of the interdigital electrode 31 in the first measuring unit 18, can be sent from said microcontroller 16 via the data line 13. A program sequence is provided in said microcontroller 16, with which a threshold loading of the particle sensor 30 is detected and a regeneration is triggered by heating up said particle sensor 30 with the heater 32. The regeneration temperature can thereby be determined by the temperature sensor 33 and be controlled via the heater voltage supply 19.

The probe control unit 10 thus makes the autonomous operation of the particle sensor 30 possible.

1. Device for operating a particle sensor in the exhaust gas duct of an internal combustion engine, the particle sensor comprising an interdigital electrode for determining the particles contained in the exhaust gas and a heater for regenerating said particle sensor and an engine management system being associated with the internal combustion engine, wherein a probe control unit is connected to said particle sensor, in that the probe control unit is disposed in a separate assembly between said particle sensor and the engine management system and in that said probe control unit is connected to said engine management system via a digital bus or an analog interface.

2. The device according to claim 1, wherein the probe control unit comprises at least an electrode voltage supply and a current measurement circuit for the interdigital electrode, a heater voltage supply for the heater, a control logic circuit and a digital bus interface for connecting to the engine management system.

3. The device according to claim 2, wherein the control logic is set up as a microcontroller with a program sequence.

4. The device according to claim 1, wherein the probe control unit contains a temperature measuring circuit for the evaluation of a temperature signal of a temperature sensor disposed on the particle sensor and a temperature control for controlling the temperature of said particle sensor.

5. Method for evaluating, activating and regenerating a particle sensor in the exhaust gas duct of an internal combustion engine having an engine management system, wherein the measuring signals of the particle sensor are supplied to a separately disposed probe control unit and in that said measuring signals are preprocessed in analog form in the probe control unit, digitalized, further processed by the control logic and forwarded to the engine management system via an analog or digital interface.

6. The method according to claim 5, wherein a comparison of the parameters of the particle sensor, a self-diagnosis of the probe control unit and the particle sensor, the triggering and control of a regeneration of said particle sensor and a comparison of operating parameters of said particle sensor take place in said probe control unit so as in each case to be considered separately or in combination of the steps of the present method.
